(19) United States
(12) Patent Application Publication
(10) Pub. No.: US 2020/0090314 A1
(43) Pub. Date: Mar. 19, 2020

(54) SYSTEM AND METHOD FOR DETERMINING A CONDITION OF AN OBJECT

(71) Applicant: Virtual Control Limited, Telegraph Bay (HK)

(72) Inventors: Florian Alexander Mayr, Telegraph Bay (HK); Thomas Pedder Bispham, JR., Telegraph Bay (HK); Tamas Ross Taldon King, Telegraph Bay (HK)

(21) Appl. No.: 16/129,916

(22) Filed: Sep. 13, 2018

(51) Int. Cl. G06T 7/00; G06N 7/00; G06K 9/62

(52) U.S. Cl. CPC G06T 7/001; G06N 7/005; G06K 9/6277; G06K 9/6263; G06T 2207/20081; G06K 9/6227; G06T 2207/20092; G06T 2207/20076; G06K 9/6253

(57) ABSTRACT

A method for determining a condition of an object, in particular whether the object is a normal condition or an abnormal condition. The method includes processing data of an object based on a determination model to determine a condition of the object. The method also includes classifying the object as in a normal condition or an abnormal condition based on the processing. The abnormal condition may indicate that the object is defective.

### TECHNICAL FIELD

The invention relates to system and method for determining a condition of an object.

### BACKGROUND

In conventional product and supply chain management, vendors have to engage professional testing, inspection and certification (TIC) company or personnel to assist them with quality inspection to ensure that the products produced are up to standard. Problematically, however, this testing, inspection and certification process is sometimes slow, and has been a rather costly exercise (salary of the personnel, multiple personnel at each production line at each geographical location, travel cost, etc.). Also, this conventional process relying solely on human judgments suffers from transparency, traceability, and potential bribery problems. There is a need to provide an improved product and supply chain management system and method to alleviate these problems.

### SUMMARY OF THE INVENTION

In accordance with a first aspect of the invention, there is provided a method for determining a condition of an object, comprising: processing data of an object based on a determination model to determine a condition of the object; and classifying the object as in a normal condition or an abnormal condition based on the processing.

Preferably, the data comprises one or more of: image data, sensed data associated with the object, and sensed data associated with an environment in which the object is arranged. The image data may include a raw image of the object or part of the object, or a processed file resulting from processing of the raw image. The sensed data may include data obtained from a sensor sensing a property of the object or the environment in which the object is arranged.

Preferably, the method further includes receiving a user input containing a user-determined condition of the object. The user-determined condition is one of a normal condition and an abnormal condition, and the user-determined condition is arranged to override the condition of the object determined using the determination model such that the classification is based on the user-determined condition.

In one embodiment, the method further includes updating the determination model based on the data and the resulting classification. For example, updating the determination model may include adjusting a determination rule or determination factor in the determination model.

In one embodiment, processing data of the object comprises comparing the data with reference data. For example, processing image data include comparing image data with reference image data; processing sensed data includes comparing sensed data with reference sensed data (e.g., range, threshold, etc.).

In one embodiment, the abnormal condition is a defective condition in which the object includes a defect. For example, processing data of the object includes identifying a defect in the object. Identifying a defect could include identifying presence or absence of defect. Alternatively, or additionally, identifying a defect may include identifying a size, location, etc., of the defect. Additionally or alternatively, processing data of the object includes determining, based on a determination rule in the determination model, a probability that the object includes a defect. Preferably, processing data of the object further includes comparing the determined probability with a probability threshold to classify the object as in the normal condition or the abnormal condition. The probability threshold is preferably adjustable by the user.

In one embodiment, classifying the object as in a normal condition or an abnormal condition based on the processing includes classifying the object based on its degree of abnormality. For example, the classification may include classifying the object as zero abnormality (i.e., normal), slightly abnormal (differ from normal by a small extent), or substantially abnormal (differ from normal by a larger extent). In the embodiment in which the probability of that the object includes a defect is determined, the classification may be based on how much the probability deviates from the probability threshold. For example, if the probability is determined to be below or equal to the probability threshold, then the object is considered normal; if the probability is determined to be above the probability threshold by a first small extent (e.g., 10%), then the object is considered slightly abnormal; if the probability is determined to be above the threshold by a larger extent (e.g., more than 10%), then the object is considered substantially abnormal. Preferably, the extent (e.g., 10%) can be adjusted. Also, such classification may be based on any number of abnormal classes. In one example, objects classified as slightly abnormal may be repaired or even accepted as “normal”; objects classified as substantially abnormal may be beyond repair and has to be scraped. Preferably, objects classified as slightly abnormal may be treated differently than objects classified as substantially abnormal.

In one embodiment in which the data includes image data, the method also includes imaging the object to obtain the image data. In one embodiment in which the data includes sensed data, the method also includes sensing a property of the object or the environment in which the object is arranged to obtain the sensed data.

Preferably, the determination model is an object-type-specific determination model that includes one or more determination rules. In one embodiment, the method also includes selecting the object-type-specific determination model from a plurality of determination models. The selection can be manual or automatic based on the processing of the data. In one embodiment in which the data includes image data, the selection can be manual or automatic based on the processing of the image data.

In this aspect, the object can be a material piece, a product or a product part. The material piece may be a raw material such as a piece of wood, metal, plastic, etc. For example, the product is a food product, a furniture piece, or any mechanical or electrical device. The product part may be a circuit board, a screw, or any mechanical or electrical components or parts.

In one embodiment, the method also includes storing the data and the associated determined condition of the object.

In one embodiment, the method also includes triggering a response when the object is classified to be in an abnormal condition. For example, the response may include providing an alarm, such as an audible alarm, a tactile alarm, etc. Other exemplary responses include: triggering a message (e.g. text message) to be sent to a computing device, automatically recording the classification of the object as normal, abnormal or with respect to any classification attribute (such recording may be in digital or any other form and in any computing device or storage medium), turning on particular signaling lights, stopping the production line (e.g., conveyor), removing the object deemed abnormal from a production line (e.g., conveyor), activating a sensor (e.g., camera) to monitor the removal of the object, etc.,

In accordance with a second aspect of the invention, there is provided a system for determining a condition of an object, comprising one or more processors arranged to process data of an object based on a determination model to determine a condition of the object; and classify the object as in a normal condition or an abnormal condition based on the processing.

Preferably, the data comprises one or more of: image data, sensed data associated with the object, and sensed data associated with an environment in which the object is arranged. The image data may include a raw image of the object or part of the object, or a processed file resulting from processing of the raw image. The sensed data may include data obtained from a sensor sensing a property of the object or the environment in which the object is arranged.

Preferably, the system further includes an input device arranged to receive a user input containing a user-determined condition of the object. The user-determined condition is one of a normal condition and an abnormal condition, and the user-determined condition is arranged to override the condition of the object determined using the determination model such that the classification is based on the user-determined condition.

In one embodiment, the one or more processors are further arranged to update the determination model based on the data and the resulting classification. For example, the one or more processors are further arranged to update the determination model by adjusting a determination rule or determination factor in the determination model.

In one embodiment, the one or more processors are arranged to process the data by comparing the data with reference data. For example, the one or more processors are arranged to process image data by comparing image data with reference image data, or the one or more processors are arranged to process sensed data by comparing sensed data with reference sensed data (e.g., range, threshold, etc.).

In one embodiment, the abnormal condition is a defective condition in which the object includes a defect. In one example, the one or more processors are further arranged to determine the condition of the object by identifying a defect in the object. Identifying a defect could include identifying presence or absence of defect. Alternatively, or additionally, identifying a defect may include identifying a size, location, etc., of the defect. Additionally or alternatively, the one or more processors are further arranged to process data of the object by determining, based on a determination rule in the determination model, a probability that the object includes a defect. Preferably, the one or more processors are further arranged to process data of the object by comparing the determined probability with a probability threshold to classify the object as in the normal condition or the abnormal condition. The probability threshold is preferably adjustable by the user.

In one embodiment, the one or more processors are arranged to classify the object as in a normal condition or an abnormal condition by classifying the object based on its degree of abnormality. For example, the one or more processors may be arranged to classify the object as zero abnormality (i.e., normal), slightly abnormal (differ from normal by a small extent), or substantially abnormal (differ from normal by a large extent). In the embodiment in which the probability of that the object includes a defect is determined, the one or more processors may perform the classification based on how much the probability deviates from the probability threshold. For example, if the probability is determined to be below or equal to the probability threshold, then the object is considered normal; if the probability is determined to be above the probability threshold by a first small extent (e.g., 10%), then the object is considered slightly abnormal; if the probability is determined to be above the threshold by a larger extent (e.g., more than 10%), then the object is considered substantially abnormal. Preferably, the extent (e.g., 10%) can be adjusted, e.g., by the user through an input device operably connected with the one or more processors. Also, such classification may be based on any number of abnormal classes. In one example, objects classified as slightly abnormal may be repaired or even accepted as “normal”; objects classified as substantially abnormal may be beyond repair and has to be scraped. Preferably, objects classified as slightly abnormal may be treated differently than objects classified as substantially abnormal.

In one embodiment the system also includes a detector, operably connected with the one or more processors, for obtaining the data. The one or more processors are arranged to receive the data, e.g., from the detector, or from other user input device. In one embodiment, the system includes an imaging device arranged to image the object to obtain the image data. In one embodiment, the system includes a sensor arranged to sense a property of the object or the environment in which the object is arranged to obtain the sensed data. In one example, the system could include one or more imaging devices and one or more sensors. The sensor could be a chemical sensor for sensing a particular chemical (e.g., presence of chemicals, concentration of chemicals) an audio sensor for sensing noise (e.g., loudness), a temperature sensor for sensing temperature of the object or the environment in which the object is arranged, a humidity sensor for sensing humidity of the object or the environment in which the object is arranged, a pressure sensor for sensing pressure of the object or the environment in which the object is arranged, etc.

Preferably, the determination model is an object-type-specific determination model that includes one or more determination rules. In one embodiment, the one or more processors are arranged to select the object-type-specific determination model from a plurality of determination models. The selection can be manual or automatic based on the processing of the data. In one embodiment in which the data includes image data, the selection can be manual or automatic based on the processing of the image data.

In this aspect, the object can be a material piece, a product or a product part. The material piece may be a raw material such as a piece of wood, metal, plastic, etc. For example, the product is a food product, a furniture piece, or any mechanical or electrical device. The product part may be a circuit board, a screw, or any mechanical or electrical components or parts.

In one embodiment, the system also includes a storage device, operably connected with the one or more processors, for storing the data and the associated determined condition of the object.

In one embodiment, the system also includes a device arranged to provide a response when the object is classified to be in an abnormal condition. For example, the response may include providing an alert using an alarm, such as an audible alarm, a tactile alarm, etc. Other exemplary response devices include: a computing device arranged to trigger a message (e.g. text message) to be sent to another computing device (e.g., mobile phone, desktop computer, etc.), automatically recording, at a computing device (e.g., mobile phone, desktop computer, etc.), the classification of the object as normal, abnormal or with respect to any classification attribute (such recording may be in digital or any other form), signaling lights arranged to be turned on, motor (e.g., for a conveyor belt) arranged to stop the production line (e.g., conveyor), a robotic arm arranged to remove the object deemed abnormal from a production line (e.g., conveyor), a sensor (e.g., camera) arranged to be activated to monitor the removal of the object, etc.

Preferably, the one or more processors are distributed on a computing server, such as a cloud computing server. Alternatively, the one or more processors are arranged in a portable electronic device (mobile phone, tablet). In another embodiment, the one more processors include at least one processor on a cloud computing server and at least one processor on a portable electronic device.

### BRIEF DESCRIPTION OF THE DRAWINGS

Embodiments of the invention will now be described, by way of example, with reference to the accompanying drawings in which:

FIG. 1 is a flow chart illustrating a method for determining a condition of an object in one embodiment of the invention;

FIG. 2 is an operation environment in which the method of FIG. 1 can be implemented;

FIG. 3 is a functional block diagram of major functions of the server in the operation environment of FIG. 2;

FIG. 4 is a flow chart illustrating a specific implementation of the method of FIG. 1 in the operation environment of FIG. 2 in one embodiment of the invention;

FIG. 5 is a flow chart illustrating a specific implementation of the method of FIG. 1 in the operation environment of FIG. 2 in another embodiment of the invention;

FIG. 6 is a flow chart illustrating a specific implementation of the method of FIG. 1 in the operation environment of FIG. 2 in yet another embodiment of the invention;

FIG. 7 is a flow chart illustrating a specific implementation of the method of FIG. 1 in the operation environment of FIG. 2 in still another embodiment of the invention;

FIG. 8 is a block diagram of the major components of the server of FIG. 2 in one embodiment of the invention; and

FIG. 9 is a block diagram of the major components of the electronic device of FIG. 2 in one embodiment of the invention.

### DETAILED DESCRIPTION OF THE PREFERRED EMBODIMENT

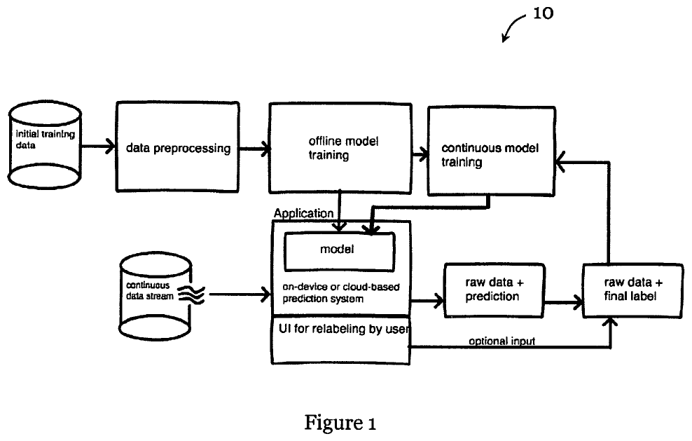

Referring to FIG. 1, there is shown a method 10 for determining a condition of an object in one embodiment of the invention. Generally, the method 10 includes (1) processing data of an object based on a determination model to determine a condition of the object and (2) classifying the object as in a normal condition or an abnormal condition based on the processing. The classification may include classifying the object based on its degree of abnormality. For example, the classification may include classifying the object as not abnormal (i.e., normal), slightly abnormal (differ from normal by a small extent), or substantially abnormal (differ from normal by a large extent). The method 10 can be applied to any object, such as a material piece, a product or a product part. The material piece may be a raw material such as a piece of wood, metal, plastic, etc. For example, the product is a food product, a furniture piece, or any mechanical or electrical device. The product part may be a circuit board, a screw, or any mechanical or electrical components or parts. The data could include comprises one or more of: image data, sensed data associated with the object, and sensed data associated with an environment in which the object is arranged. In the following description, reference is made to the data being image data. However, it should be noted that the data is not limited to image data but may additionally or alternatively be sensed data.

In this embodiment, the determination model is embodied in an application arranged to be operated in an environment with an electronic device, a server, or like computing devices. The determination model includes rules for determining whether the object is in a normal condition or an abnormal condition. Preferably, the determination model is object-type-specific, i.e., the model is arranged for application is specific types of object. The abnormal condition may refer to a defective condition in which the object includes a defect, in which case the determination model is arranged to assist identification of defect in the object. This may involve, e.g., processing the image data of the object by comparing the image data with reference image data, then determining, based on the determine rules, a probability that the object includes a defect. If the determined probability is above a defect-free threshold probability, then the object is considered to be free of defects; otherwise, the object is considered to be defective. The probability threshold preferably can be adjusted based on the type of object to be inspected, the user's tolerance to defects, etc.

The determination model is trainable, e.g., by machine learning, deep learning, domain adaption, etc. As shown in FIG. 1, offline model training is performed by first preprocessing initial training data and using the preprocessed data to formulate or adjust determination rules in the determination model. The initial training data could include image data of object and associated determination decision as to whether the related image data indicates normal or abnormal condition. In one example, one or more determination factors or parameters in the determination rules is adjusted through training. Alternatively or additionally, one or more determination rules in the model may be added or removed through training. The determination model can also be continuously trained during operation. In operation, an electronic device, server, or like computing device may use the determination model to process image data for classifying condition of the object. A data stream, preferably continuous, is fed to the computing device running the determination model. The computing device classifies the object as normal or abnormal based on processing of its related image data using the determination model. The determined (or predicted) classification and the associated image data is used to continuously train the determination model. In one example, the determined (or predicted) classification and the associated image data can be stored. In a preferred embodiment, a user interface may be provided at a computing device showing the classification determined by the model and the associated image data. The user may, through the computing device, input a user-determined classification of the condition of the object, i.e., whether the user thinks that the object is normal or abnormal based on the image data. The user determined classification can override the classification determined using the determination model. If the user-determined classification matches the determination-model-determined classification, then the user input can be considered as a confirmatory input; if the user-determined classification does not match the determination-model-determined classification, then the user input can be considered as an overriding input. The determination model would be trained, like described above with respect to offline training, using the user input and the associated image data. The situations in which the user-determined classification differs from the model-determined classification is especially important for improving the model over time as the user's decisions can be considered as a source of truth. In the event that the object is classified as abnormal, or defective, a response may be triggered. For example, the response may include providing an alarm, such as an audible alarm, a tactile alarm, etc. Other exemplary responses include: triggering a message (e.g. text message) to be sent to a computing device, automatically recording, at a computing device (e.g., mobile phone, desktop computer, etc.), the classification of the object as normal, abnormal or with respect to any classification attribute (such recording may be in digital or any other form), turning on particular signaling lights, stopping the production line (e.g., conveyor), removing the object deemed abnormal from a production line (e.g., conveyor), activating a sensor (e.g., camera) to monitor the removal of the object, etc.,

For simplicity, only one determination model is described with respect to FIG. 1. It should be appreciated that in some determination tasks, multiple models may be applied to the same image data to improve determination accuracy. In some example, the determination model(s) to be used can be first selected from a determination model database, either manually by user selection, or automatically by processing the image data and recognizing the type of object associated with the image data.

It should be appreciated that the method 10 in FIG. 1 can be applied in various applications and can be largely generic. In one example, the method 10 in FIG. 1 can be applied to various inspection applications, such as but not limited to inspection of wood knots, wood grain quality, metal imperfections, plastic imperfections, logo printing, OCR for text, etc. In the exemplary application of recognizing knots in wood pieces, the model can be trained to classify knots according to the size or other metrics. And by using the model, different pieces of wood can be classified depending on the user determined tolerance. Alternatively, the method 10 can be used at a pizza shop to deliver a quality score on the uniformity of cheese distribution (based on image data of the pizza), or at a coffee shop to provide a quality score for latte art (based on image data of the coffee). The method 10 readily facilities applications transition between different domains, by training a new model and plugging it into the existing architecture. Preferably, users (e.g., operators) can override the model's determination, but this is not essential. In some embodiments, the resulting classification result and data as processed using the determination model can be added to preexisting data about the specific process. In the inspections example, quality scores, OCR-derived text, and annotations about where defects exist within an image can be added to databases that are recording information about a specific purchase order (an order for objects to be made in the factory). This allows the data collected at the inspection site to be seamlessly added to the offline process to be accessed by relevant personnel remote from the inspection site. It should be noted that the method 10 in FIG. 1 can be applied in one company across various geographical locations, or can be applied in multiple companies in the same field (e.g., using similar types of material pieces, making similar types of products or product parts) across various geographical locations. The latter case is advantageous because the determination model can be trained with various sources of information to become more accurate, and yet different companies may apply different determination standards/probability thresholds to adapt the model to their specific needs. In some embodiments, the method 10 may utilize OCR technology for the capturing of serial, batch and dimensional measurements of the object to be inspected. Digital measuring tools such as calipers, tape measures and sensors (humidity, temperature, etc.) on electronic devices can be used to reduce human error.

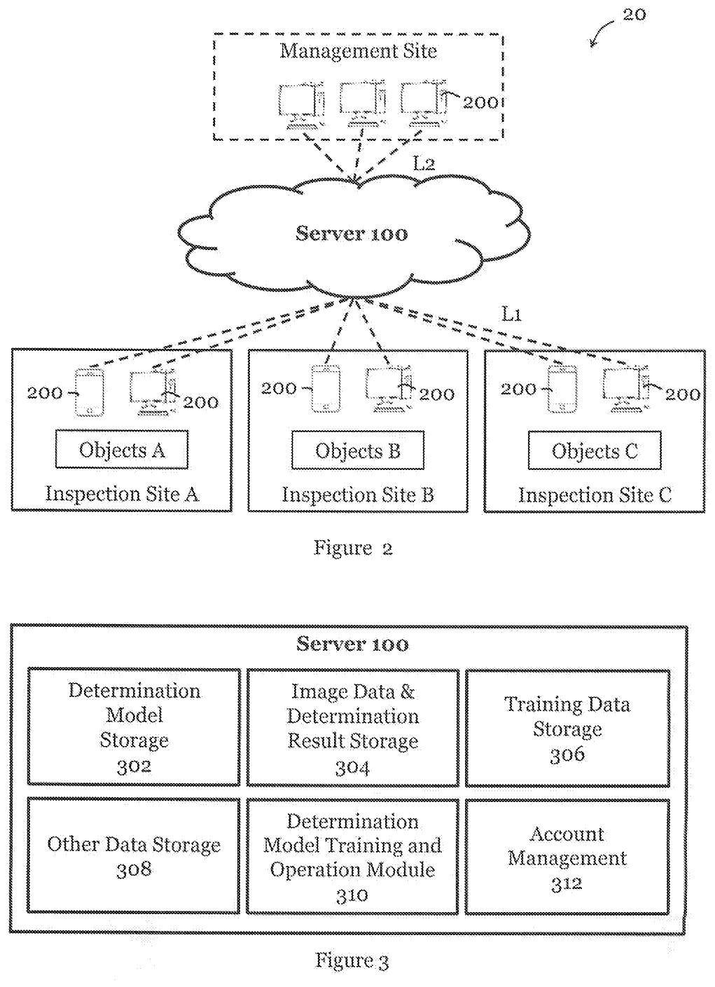

FIG. 2 is an operation environment 20 in which the method 10 of FIG. 1 can be employed. The operation environment 20 in FIG. 2 includes a server 100, electronic devices 200 at different inspection sites A, B, C, and electronic devices 200 at a management site. The inspection sites and the management sites can be at different geographical locations. The inspection sites can be of the same enterprise or of different enterprises. The management site is optional. In this embodiment, the server 100 is arranged to host or store the determination models. The electronic devices 200 at inspection sites A, B, C are arranged to perform inspection on objects (material piece, product, product part, etc.) to determine whether the object is normal or abnormal (e.g., defective). The objects may be of the same or similar-enough type such that the electronic devices 200 use the same determination model(s) for determination of condition of the object. In this example, the electronic devices 200 are in the form of a phone, tablet computer, or a desktop computer, but effectively any electronic computing devices can be used. The electronic devices 200 preferably include imaging devices, such as camera, for obtaining image data of the object to be inspected. The electronic devices 200 at the management site can be used to access information associated with the inspection at inspection sites A, B, and C. Also, the electronic devices 200 at the management site can be used monitor and management the inspection process at these sites A, B, C. User-determined classification as described above with respect to FIG. 1 can be provided from these electronic devices 200 at the management site to verify the performance of the classification by the model. In one embodiment, the users at the management site do not provide user-determined classification at the electronic devices 200 at the management site but the users at the inspection site do, using the electronic devices 200 at the inspection site. In some embodiments, the management site and inspection site can be combined.

In the system of FIG. 2, the server 100 and the electronic devices 200 at the inspection sites are operably connected through communication links L1. The communication link L1 may be a wired or a wireless communication link, preferably secured and encrypted. Likewise, the server 100 and the electronic devices 200 at the management site are operably connected through communication links L2. The communication link L2 may be a wired or a wireless communication link, preferably secured and encrypted.

FIG. 3 is a functional block diagram of major functions of the server 100 in the operation environment 20 of FIG. 2. As shown in FIG. 3, the server 100 includes a determination model storage 302 arranged to store multiple determination models, each including one or more determination rules, factors, parameters, etc. The server 100 also includes an image data and determination result storage 304 to store the image data and associated determination result. As the server 100 operates, more and more data will be aggregated in the image data and determination result storage 304. A training data storage 306 is arranged to store the training data for training the determination models. The training data includes image data of object and associated determination decision as to whether the related image data indicates normal or abnormal condition. The training data can be regularly updated, by adding new training data, deleting old training data, etc. The training data can be determination-model-specific. A further data storage 308 is arranged to store information associated with the image data, such as the time stamp, quality scores, OCR-derived text, and annotations. Other information such as purchase order information, packing information, batch information, production and shipping information can also be stored in the further data storage 308. A determination model training and operation module 310 is arranged to train the determination models, e.g., using the training data in the training data storage 306, or the image data and resulting denervation result in the image data and determination result storage 304, or both. The training and operation module 310 may regularly update the determination models in the storage 302 using these data. The server 100 also provides an account management model 312. The account management module 312 manages account of the user, e.g., a particular enterprise, or an office of a particular enterprise. User-determined/defined information such as types of objects to be inspected, determination model(s) to be used, determination thresholds or probabilities associated with particular determination model, etc., can be managed in this module 312. In the embodiments in which the server 100 is arranged for managing inspection processes for multiple enterprises, the server 100 stores account information for each respective enterprise.

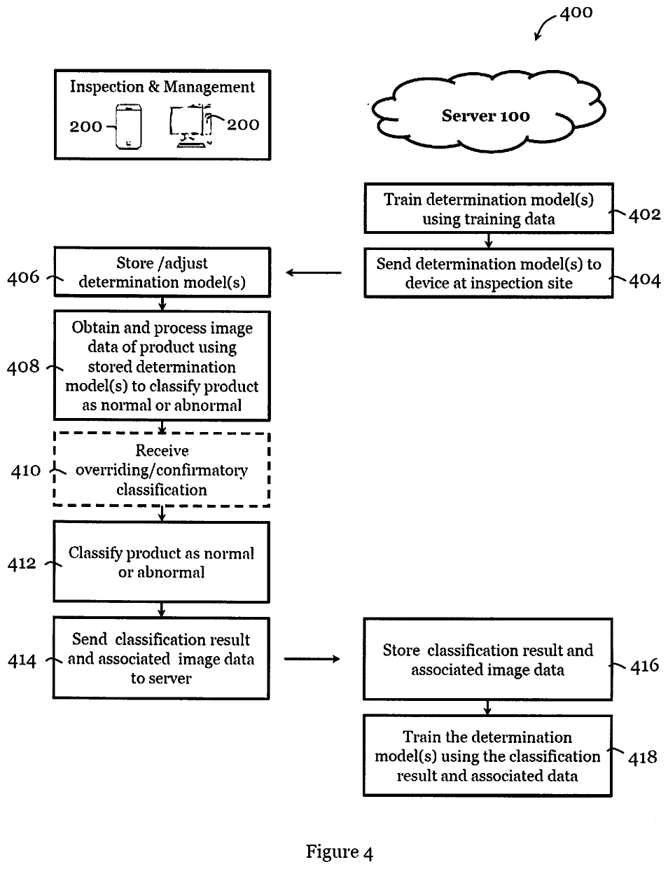

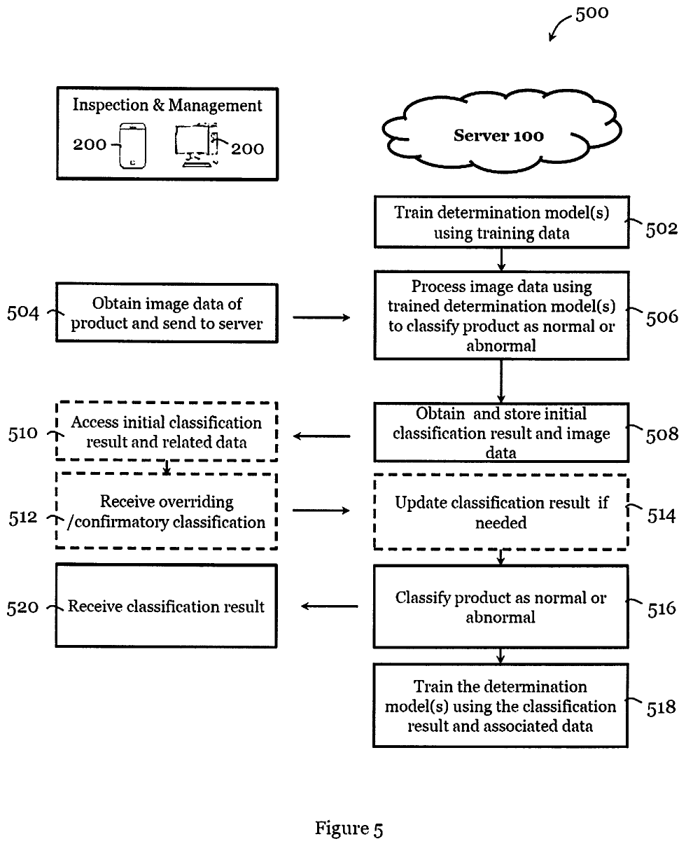

FIG. 4 is a specific embodiment in which the method 10 of FIG. 1 can be implemented in the environment 20 of FIG. 2. In this example, the inspection and management are performed at the same site. The method 400 begins in step 402, in which the determination models are trained using the respective applicable training data. This step can be performed offline, independently at the server 100. Then in step 404, when inspection is to be performed, the user login to the system using the electronic device 200, and the server 100 transmits the corresponding determination models to the electronic device 200. The determination models to be transmitted may be based on user selection or user selected inspection task. In step 406, the determination model(s) are received at the electronic device 200 at the inspection and management site. Upon receiving the determination models, the user can adjust parameter settings in the determination models, e.g., to adjust tolerance by changing the probability that determines whether the condition is normal or abnormal. The method 400 then proceeds to step 408, in which the electronic device 200 obtains image data of the object. The electronic device 200 processes the obtained image data using the stored and optionally adjusted determination model(s) to determine whether the product is normal or abnormal. A determination result is obtained. Then, optionally, in step 410, the user may review the determination made by the model. The user may input, at the electronic device 200, an overriding or confirmatory classification, which m overrides the model-determined classification regardless of the classification result. In step 412, the electronic device 200 classifies the object as normal or abnormal. If an overriding or confirmatory classification is received at step 410, then the electronic device 200 classifies the object as normal or abnormal based on the overriding or confirmatory classification. If step 410 is not performed, the electronic device 200 classifies the object as normal or abnormal based on the model-determined classification. In step 414, the electronic device 200 sends the classification result and the associated image data to the server 100 for storage at the server 100 in step 416. The server 100 may then, in step 418, uses the received classification result and associated data to train the corresponding determination model(s).

FIG. 5 is another specific embodiment in which the method 10 of FIG. 1 can be implemented in the environment 20 of FIG. 2. In this example, the inspection and management are performed at the same site. The main difference between the method 500 in this embodiment and the method 400 in FIG. 4 is that the determination model(s) in the method 500 of this embodiment is not transmitted to the electronic device 200 at the inspection and management site, and the processing is performed largely at the server 100.

The method 500 begins in step 502, in which the determination models are trained using the respective applicable training data. This step can be performed offline, independently at the server 100. Then in step 504, when inspection is to be performed, the user login to the system using the electronic device 200. The user obtains image data of the product and sends the data to the server 100. The server 100, up receiving the image data in step 506, processes the data using determination model(s) to classify product as normal or abnormal. The server 100 may automatically select the appreciate determination model(s) to used based on the processing, or alternatively, the server 100 may use the determination model(s) selected by the user. In step 508, the server 100 obtains an initial classification result. The server 100 stores the initial classification result and the associated image data. Optionally, in step 510, the user may access and review the initial classification result (and associated data) determined by the server 100, either actively by querying the server 100 or passively based on information or notification received from the server 100. In step 512, the user may, based on his/her independent review of the data, input an overriding or confirmatory classification, which overrides the model-determined classification regardless of the classification result. If such user input is provided at the electronic device 200, then the user determined classification is transmitted to the server 100 to override the classification made by the model, as in step 514. In step 516, the server 100 classifies the object as normal or abnormal. If an overriding or confirmatory classification is received at step 514, then the server 100 classifies the object as normal or abnormal based on the overriding or confirmatory classification. If steps 512 and 514 are not performed, the electronic device 200 classifies the object as normal or abnormal based on the model-determined classification in step 508. In step 518, the server 100 uses the classification result and associated data to train the corresponding determination model(s). The server 100 may, in step 520, transmit the final classification result to the electronic device 200 at the inspection and management site so that appropriate action can be taken in respect of the object determined to be normal or abnormal.

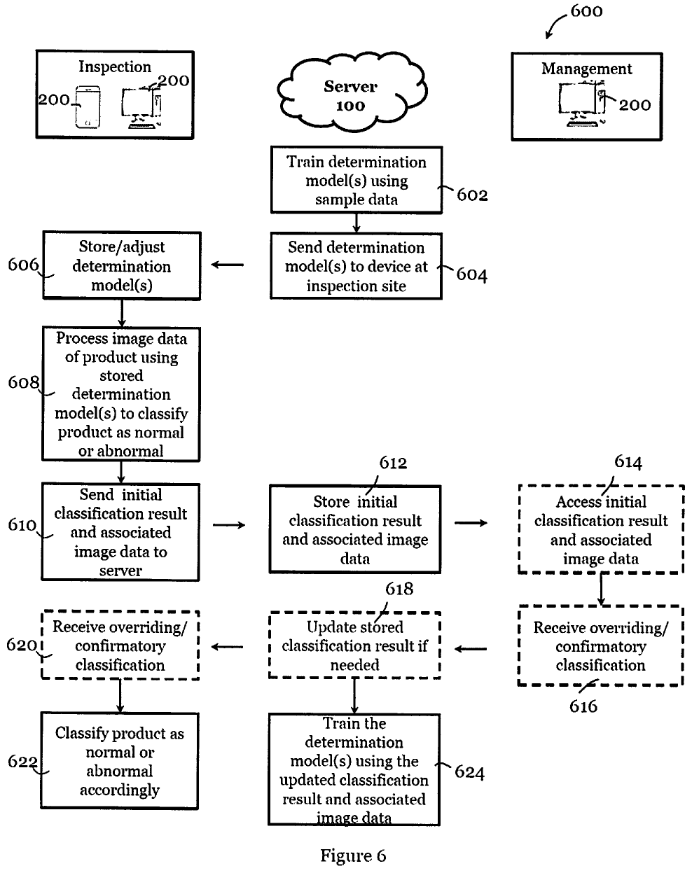

FIG. 6 is a specific embodiment in which the method 10 of FIG. 1 can be implemented in the environment 20 of FIG. 2. In this example, the inspection and management are performed at separate sites. The method 600 begins in step 602, in which the determination models are trained using the respective applicable training data. This step can be performed offline, independently at the server 100. Then in step 604, when inspection is to be performed, the user login to the system using the electronic device 200 at the inspection site, and the server 100 transmits the corresponding determination models to the electronic device 200. The determination models to be transmitted may be based on user selection or user selected inspection task. In step 606, the determination model(s) are received at the electronic device 200 at the inspection site. Upon receiving the determination models, the user can adjust parameter settings in the determination models, e.g., to adjust tolerance by changing the probability that determines whether the condition is normal or abnormal. The method 600 then proceeds to step 608, in which the electronic device 200 obtains image data of the object. The electronic device 200 processes the obtained image data using the stored and optionally adjusted determination model(s) to determine whether the product is normal or abnormal. A determination result is obtained. Steps 602 to 608 in method 600 of this embodiment are similar to steps 402 to 408 in the method 400 of FIG. 4.

Then, in step 610, the electronic device 200 at the inspection site sends the initial classification result and associated image data to the server 100. The server 100 stores this information in step 612. Optionally, in step 614, a user at the management site remote from the inspection site may review the determination made by the model. In step 616, the user at the management site may input, through the electronic device 200 at the management site, an overriding or confirmatory classification, which overrides the model-determined classification regardless of the classification result. In step 618, the server 100 updates the classification result based on the user input received from the electronic device 200 at the management site. The server 100 relays the user input to the electronic device 200 at the inspection site, in step 620. Then, subsequently, in step 622, the electronic device 200 at the inspection site classifies the object as normal or abnormal. If an overriding or confirmatory classification is received at step 620, then the electronic device 200 classifies the object as normal or abnormal based on the overriding or confirmatory classification. If steps 616 to 620 are not performed (e.g., no management site electronic device 200 was determined to be online, or no signal from management site electronic device 200 after a predetermined period), the electronic device 200 at the inspection site classifies the object as normal or abnormal based on the model-determined classification, in step 622. In step 624, the server 100 may use the final classification result and associated data to train the corresponding determination model(s).

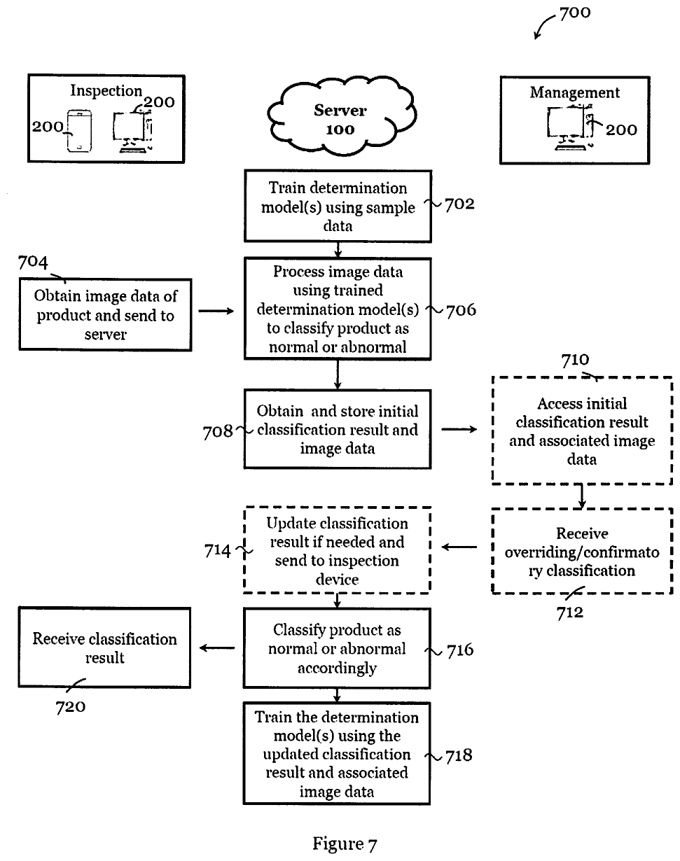

FIG. 7 is another specific embodiment in which the method 10 of FIG. 1 can be implemented in the environment 20 of FIG. 2. In this example, the inspection and management are performed at the separate sites. The main difference between the method 700 in this embodiment and the method 600 in FIG. 6 is that the determination model(s) in the method 700 of this embodiment is not transmitted to the electronic device 200 at the inspection site, and the processing is performed largely at the server 100.

The method 700 begins in step 702, in which the determination models are trained using the respective applicable training data. This step can be performed offline, independently at the server 100. Then in step 704, when inspection is to be performed, the user login to the system using the electronic device 200 at the inspection site. The user at the inspection site obtains image data of the product and sends the data to the server 100. The server 100, up receiving the image data in step 706, processes the data using determination model(s) to classify product as normal or abnormal. The server 100 may automatically select the appreciate determination model(s) to used based on the processing, or alternatively, the server 100 may use the determination model(s) selected by the user. In step 708, the server 100 obtains an initial classification result. The server 100 stores the initial classification result and the associated image data. Optionally, in step 710, a user at the management site, using the electronic device 200 at the management site, may access and review the initial classification result (and associated data) determined by the server 100, either actively by querying the server 100 or passively based on information or notification received from the server 100. In step 712, the user at the management site may, based on his/her independent review of the data, input an overriding or confirmatory classification, which overrides the model-determined classification regardless of the classification result. If such user input is provided at the electronic device 200 at the management site, then the user determined classification is transmitted to the server 100 to override the classification made by the model, as in step 714. In step 716, the server 100 classifies the object as normal or abnormal. Specifically, if an overriding or confirmatory classification is received at step 714, then the server 100 classifies the object as normal or abnormal based on the overriding or confirmatory classification. If steps 712 and 714 are not performed, the electronic device 200 classifies the object as normal or abnormal based on the model-determined classification in step 708. In step 718, the server 100 uses the classification result and associated data to train the corresponding determination model(s). The server 100 may, in step 720, transmit the final classification result to the electronic device 200 at the inspection site so that appropriate action can be taken in respect of the object determined to be normal or abnormal.

FIGS. 4 to 7 illustrate some exemplary embodiments in which the method 10 of FIG. 1 can be implemented in the environment 20 of FIG. 2. It should be noted that, however, the method 10 of FIG. 1 can be implemented in the system of FIG. 2 in other various ways. Also, some of the steps in the methods 400, 500, 600, 700 in FIGS. 4 to 7 are optional, additional steps can be added, and some of the steps need not be performed in the order illustrated. For example, in the embodiment of FIGS. 4 and 5, the determination models to be transmitted to the electronic device 200 is not based on user selection but is based on initial image data transmitted from the device to the server 100. In this case, the server 100 can process the initial image data to determine the type of object to be inspected and hence the appropriate determination models. In the embodiments of FIGS. 4 to 7, the overriding/confirmatory classification may not be provided in which case the method 400, 500, 600, 700 uses the determination-model-determined classification as the classification result. In some examples, the determination model is not updated using the determination-model-determined classification and associated data. Although the methods 400, 500, 600, 700 in FIGS. 4 to 7 are described as applied to products, the methods 400, 500, 600, 700 can be applied to any object such as material piece, product, or product parts. Importantly, the training of the determination model(s) in the above embodiments could be on-the-fly. That is, the training can be performed as the inspection continues. Preferably, in the embodiments of Figures 4 and 6, the updated or trained determination model(s) may be transmitted to the electronic devices 200 during inspection to continuously keep the determination model(s) most up to date.

In the embodiment of FIGS. 1 to 7, the systems and methods are described with respect to image data, i.e., processing image data of an object based on a determination model to classify the object as normal or abnormal (e.g., defective). However, it should be noted that the data used need not be limited to image data, but may additionally or alternatively include sensed data associated with the object or an environment in which the object is arranged. The sensed data may include data obtained from one or more sensors sensing a respective property of the object or the environment in which the object is arranged. The sensor may be: a chemical sensor for sensing a particular chemical (e.g., presence of chemicals, concentration of chemicals) an audio sensor for sensing noise (e.g., loudness), a temperature sensor for sensing temperature of the object or the environment in which the object is arranged, a humidity sensor for sensing humidity of the object or the environment in which the object is arranged, a pressure sensor for sensing pressure of the object or the environment in which the object is arranged, etc. In the embodiment with sensed data, the sensed data may be processed based on a determination model to classify the object as normal or abnormal (e.g., defective). This may include, for example, comparing the sensed data with a predetermined range, threshold, etc. For example, if the sensed data relates to temperature of the object, then the comparison may involve comparing the sensed temperature with predetermined threshold(s) or range for classifying the condition of the object. In some embodiments, the systems and methods may use both image data and sensed data (from one or more sources) for classifying the object as normal or abnormal.

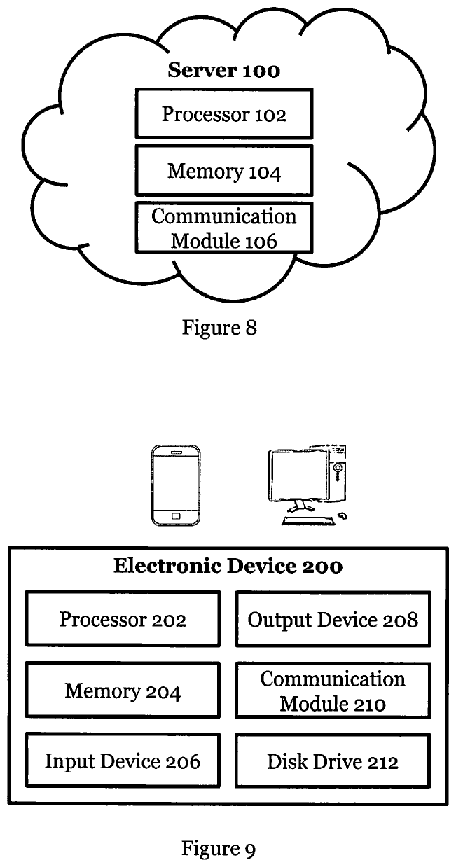

Referring to FIG. 8, there is shown a schematic diagram of an exemplary information handling system that can be used as the server 100 in one embodiment of the invention. The information handling system may have different configurations, and it generally comprises suitable components necessary to receive, store, and execute appropriate computer instructions, commands, or codes. The main components of the server 100 are a processor 102 and a memory unit 104. The processor 102 may be formed by one or more CPU, MCU, controllers, logic circuits, Raspberry Pi chip, etc. The memory unit 104 may include one or more volatile memory unit (such as RAM, DRAM, SRAM), one or more non-volatile unit (such as ROM, PROM, EPROM, EEPROM, FRAM, MRAM, FLASH, SSD, NAND, and NVDIMM), or any of their combinations. The information handling system 200 also preferably includes a communication module 106 for establishing one or more communication links (not shown) with one or more other computing devices such as servers, personal computers, terminals, tablets, phones, or other wireless or handheld computing devices. The communication module 106 may be a modem, a Network Interface Card (NIC), an integrated network interface, a radio frequency transceiver, an optical port, an infrared port, a USB connection, or other wired or wireless communication interfaces. The communication links may be wired or wireless for communicating commands, instructions, information and/or data. For example, the communication link may be a Bluetooth®, Wi-Fi®, ZigBee®, near-field communication (NFC), radio frequency identification (RFID), etc. Preferably, the processor 102, the memory unit 104, and the communication module 106 are connected with each other through a bus, a Peripheral Component Interconnect (PCI) such as PCI Express, a Universal Serial Bus (USB), an optical bus, or other like bus structure. In one embodiment, some of these components may be connected through a network such as the Internet or a cloud computing network. A person skilled in the art would appreciate that the server 100 shown in FIG. 8 is merely exemplary and different information handling systems with different configurations may be used to implement the server 100. The server 100 can be implemented on a cloud computing network but this is not essential.

Referring to FIG. 9, there is shown a schematic diagram of an exemplary information handling system that can be used as the electronic device 200 in one embodiment of the invention. The information handling system may have different configurations, and it generally comprises suitable components necessary to receive, store, and execute appropriate computer instructions, commands, or codes. The main components of the electronic device 200 are a processor 202 and a memory unit 204. The processor 202 may be formed by one or more CPU, MCU, controllers, logic circuits, Raspberry Pi chip, etc. The memory unit 204 may include one or more volatile memory unit (such as RAM, DRAM, SRAM), one or more non-volatile unit (such as ROM, PROM, EPROM, EEPROM, FRAM, MRAM, FLASH, SSD, NAND, and NVDIMM), or any of their combinations. Preferably, the information handling system 200 further includes one or more input devices 206 such as a keyboard, a mouse, a stylus, an image scanner, a microphone, a tactile input device (e.g., touch sensitive screen), and an image/video input device (e.g., camera), operably connected with the processor 202. Preferably, the input device 206 would include at least one imaging device to capture image data of the objects. The imaging device may be a camera (film or digital), an infrared imager, UV imaging device, X-Ray imaging device, radioactive dyes imager, laser imaging device, Microwave imaging device, or like optical devices. Additionally or alternatively, the input device 206 would include at least one sensor arranged to sense a property of the object or the environment in which the object is arranged. The sensor could be a chemical sensor for sensing a particular chemical (e.g., presence of chemicals, concentration of chemicals) an audio sensor for sensing noise (e.g., loudness), a temperature sensor for sensing temperature of the object or the environment in which the object is arranged, a humidity sensor for sensing humidity of the object or the environment in which the object is arranged, a pressure sensor for sensing pressure of the object or the environment in which the object is arranged, etc. The information handling system 200 may further include one or more output devices 208 such as one or more displays (e.g., monitor), speakers, disk drives, headphones, earphones, printers, 3D printers, etc. The display may include a LCD display, a LED/OLED display, or any other suitable display that may or may not be touch sensitive. The information handling system 200 may further include one or more disk drives 212 which may encompass solid state drives, hard disk drives, optical drives, flash drives, and/or magnetic tape drives. A suitable operating system may be installed in the information handling system 200, e.g., on the disk drive 212 or in the memory unit 204. The memory unit 204 and the disk drive 212 may be operated by the processor 202. The information handling system 200 also preferably includes a communication module 210 for establishing one or more communication links (not shown) with one or more other computing devices such as servers, personal computers, terminals, tablets, phones, or other wireless or handheld computing devices. The communication module 210 may be a modem, a Network Interface Card (NIC), an integrated network interface, a radio frequency transceiver, an optical port, an infrared port, a USB connection, or other wired or wireless communication interfaces. The communication links may be wired or wireless for communicating commands, instructions, information and/or data. For example, the communication link may be a Bluetooth®, Wi-Fi®, ZigBee®, near-field communication (NFC), radio frequency identification (RFID), etc. Preferably, the processor 202, the memory unit 204, and optionally the input devices 206, the output devices 208, the communication module 210 and the disk drives 212 are connected with each other through a bus, a Peripheral Component Interconnect (PCI) such as PCI Express, a Universal Serial Bus (USB), an optical bus, or other like bus structure. In one embodiment, some of these components may be connected through a network such as the Internet or a cloud computing network. A person skilled in the art would appreciate that the electronic device 200 shown in FIG. 2 is merely exemplary and different information handling systems with different configurations may be used to implement the electronic device 200.

The systems and methods in the above embodiments of the present invention facilitate modernization of processes in-factory for various objects (material pieces, products, and product parts) are they are being manufactured and assembled, thereby improving smartness of factories and enterprises in general. The systems and methods provide determination model(s) for determining conditions of objects. The determination model(s) is machine learning and determination model(s) that improve over time (with more data and result). The systems and methods in the above embodiment, combined with computer vision, could assist and automate various repetitive inspection processes that are used to ensure quality of the final product. Using the systems and methods in the above embodiments, retailers and vendors can build more trust based relationships. Vendors can better control and manage their production line and hence improve product quality. In some cases in which a third party independent of the vendors may operate the management site to oversee multiple lines of multiple factories. Also, the systems and methods can improve transparency and efficiency in supply chain management, lower operational costs for standard inspections, and increase speed to market for products.

In one exemplary application, the systems and methods in the above embodiments can be used in a leather handbag factory, to inspect incoming raw material, intermediate product, final product, or even the operation process. The resulting benefits include reduced waste, rework, time, and cost, reduced manpower requirements, and improved transparency and traceability.

In another exemplary application, the systems and methods in the above embodiments can be used in inspection of electronics and medical devices. The determination models can be specifically arranged to detect defects in high value highly sensitivity product categories. The systems can be accompanied with human visual inspections with plug/play capability. Laboratory grade test equipment and machines allow for maximum impact of the determination models. The resulting benefits include the provision of advanced model algorithm suitable for use across industries to detect defects, improved anti-counterfeiting for electronic components, and improved automation to remove inspection subjectivity for high value products.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include any appropriate arrangement of computer or information processing hardware capable of implementing the function described.

It will be appreciated by persons skilled in the art that numerous variations and/or modifications may be made to the invention as shown in the specific embodiments without departing from the spirit or scope of the invention as broadly described. In particular, features disclosed in one embodiment may be combined with one or more features in another embodiment of form new embodiment within the scope of the invention as defined by the claims. The described embodiments of the invention should therefore be considered in all respects as illustrative, not restrictive.

1. A method for determining a condition of an object, comprising:
processing data of an object based on a determination model to determine a condition of the object; and
classifying the object as in a normal condition or an abnormal condition based on the processing.

2. The method of claim 1, wherein the data comprises
image data; or
sensed data associated with the object or an environment in which the object is arranged.

3. The method of claim 2, further comprising:
receiving a user input containing a user-determined condition of the object, the user-determined condition is one of a normal condition and an abnormal condition, and the user-determined condition is arranged to override the condition of the object determined using the determination model such that the classification is based on the user-determined condition.

4. The method of claim 3, further comprising:
updating the determination model based on the data and the resulting classification.

5. The method of claim 4, wherein updating the determination model comprises adjusting a determination rule or determination factor in the determination model.

6. The method of claim 2, wherein processing data of the object comprises comparing the data with reference data.

7. The method of claim 2, wherein the abnormal condition is a defective condition in which the object includes a defect; and processing data of the object comprises identifying a defect in the object.

8. The method of claim 7, wherein processing data of the object comprises determining, based on a determination rule in the determination model, a probability that the object includes a defect.

9. The method of claim 8, wherein processing data of the object further comprises comparing the determined probability with a probability threshold to classify the object as in the normal condition or the abnormal condition.

10. The method of claim 9, wherein the probability threshold is adjustable by the user.

11. The method of claim 2, wherein the determination model is an object-type-specific determination model that includes one or more determination rules.

12. The method of claim ii, further comprising selecting the object-type-specific determination model from a plurality of determination models.

13. The method of claim 12, wherein the selection is automatic and is based on the processing of the data.

14. The method of claim 2, wherein the object is a material piece, a product, or a product part.

15. The method of claim 2, further comprising:
triggering a response when the object is classified to be in an abnormal condition.

16. A system for determining a condition of an object, comprising:
one or more processors arranged to process data of an object based on a determination model to determine a condition of the object; and
classify the object as in a normal condition or an abnormal condition based on the processing.

17. The system of claim 16, wherein the data comprises
image data; or
sensed data associated with the object or an environment in which the object is arranged.

18. The system of claim 17, further comprising:
an input device arranged to receive a user input containing a user-determined condition of the object, the user-determined condition is one of a normal condition and an abnormal condition, and the user-determined condition is arranged to override the condition of the object determined using the determination model such that the classification is based on the user-determined condition.

19. The system of claim 18, wherein the one or more processors are further arranged to update the determination model based on the data and the resulting classification, by adjusting a determination rule or determination factor in the determination model.

20. The system of claim 17, wherein the one or more processors are arranged to process the data by comparing the data with reference data.

21. The system of claim 17, wherein the abnormal condition is a defective condition in which the object includes a defect; and
wherein the one or more processors are further arranged to determine the condition of the object by identifying a defect in the object.

22. The system of claim 21, wherein the one or more processors are further arranged to
process data of the object by determining, based on a determination rule in the determination model, a probability that the object includes a defect; and
compare the determined probability with a probability threshold to classify the object as in the normal condition or the abnormal condition.

23. The system of claim 17, further comprising a detector, operably connected with the one or more processors, for obtaining the data; and the one or more processors are arranged to receive the data.

24. The system of claim 17, wherein the determination model is an object-type-specific determination model that includes one or more determination rules.

25. The system of claim 24, wherein the one or more processors are arranged to select the object-type-specific determination model from a plurality of determination models.
